(19) United States
(12) Patent Application Publication
(10) Pub. No.: US 2025/0205819 A1
(43) Pub. Date: Jun. 26, 2025

(54) LASER WELDING DEVICE AND LASER WELDING METHOD

(71) Applicant: KABUSHIKI KAISHA TOSHIBA, Tokyo (JP)

(72) Inventors: Tomoki TSUKADA, Yokohama Kanagawa (JP); Masakazu KIKAWADA, Yokohama Kanagawa (JP)

(21) Appl. No.: 18/915,225

(22) Filed: Oct. 14, 2024

(30) Foreign Application Priority Data
Dec. 21, 2023 (JP) 2023-215433

(51) Int. Cl. B23K 26/21; B23K 26/08

(52) U.S. Cl. CPC B23K 26/21; B23K 26/0876

(57) ABSTRACT

A laser welding device includes a laser irradiation part configured to irradiate a laser beam on a welding position of a member, a shielding gas supply part configured to supply a shielding gas to the welding position of the member, an imaging part configured to capture an image of a weld pool formed by irradiating the laser beam on the welding position of the member, and a controller configured to predict, based on the image of the weld pool, a state inside a weld portion formed by the weld pool solidifying. The controller predicting the state inside the weld portion based on at least one of a variance of a change amount of a luminance of a surface of the weld pool, a number of spatter at the surface of the weld pool, or a number of bubbles at the surface of the weld pool.

### CROSS-REFERENCE TO RELATED APPLICATIONS

This application is based upon and claims the benefit of priority from Japanese Patent Application No. 2023-215433, filed on Dec. 21, 2023; the entire contents of which are incorporated herein by reference.

### FIELD

Embodiments described herein relate generally to a laser welding device and a laser welding method.

### BACKGROUND

For example, there are cases where two members are arranged proximate to each other, and a laser beam is irradiated on an end portion of one member and an end portion of the other member adjacent to the one member to weld the end portions of the two members to each other.

Here, a shielding gas such as nitrogen gas or the like is supplied to the welding position of the members to shield the welding position of the members. However, there are cases where a gas (e.g., air) in the environment may mix with the shielding gas and become trapped in a weld pool formed by the irradiation of the laser beam. When the gas is trapped in the weld pool, there are cases where a blow hole occurs inside the weld portion. When there are blow holes inside the weld portion, the substantial cross-sectional area of the weld portion is reduced, and so the tensile strength of the weld portion may be reduced, and/or the tensile strength of the weld portion may fluctuate. In such a case, if the state inside the weld portion is confirmed by X-ray measurements, cutting the weld portion, etc., a new problem arises in that it requires time and effort.

Technology that detects a defect of a weld portion has been proposed in which an external dimension of the weld portion is measured using a CCD camera, etc. However, the state inside the weld portion cannot be determined by measuring the external dimension of the weld portion.

It is therefore desirable to develop technology that can easily determine the state inside the weld portion.

### BRIEF DESCRIPTION OF THE DRAWINGS

FIG. 1 is a schematic view illustrating a laser welding device according to an embodiment;

FIG. 2 is a schematic view illustrating laser welding of end portions of two wire-shaped members;

FIGS. 3A and 3B are photographs illustrating blow holes;

FIG. 4 is a graph illustrating a relationship between the percentage of air mixed in the shielding gas and the occurrence count of blow holes;

FIG. 5 is a photograph illustrating a method for confirming the occurrence of blow holes;

FIG. 6 is a photograph illustrating a luminance of a surface of a weld pool;

FIG. 7 is a graph illustrating a change amount of the luminance of the surface of the weld pool;

FIG. 8 is a graph illustrating a relationship between the variance of the change amount of the luminance and the number of blow holes;

FIG. 9 is a photograph illustrating spatter;

FIG. 10 is a graph illustrating a relationship between the number of spatter and the number of blow holes;

FIG. 11 is a graph illustrating a relationship between the number of bubbles and the number of blow holes;

FIG. 12 is a photograph illustrating a cross section of a reworked weld portion;

FIG. 13 is a graph illustrating effects of the reworking; and

FIG. 14 is a schematic view illustrating a movement path of an irradiation position of a laser beam when reworking.

### DETAILED DESCRIPTION

A laser welding device according to an embodiment includes a laser irradiation part configured to irradiate a laser beam on a welding position of a member, a shielding gas supply part configured to supply a shielding gas to the welding position of the member, an imaging part configured to capture an image of a weld pool formed by irradiating the laser beam on the welding position of the member, and a controller configured to predict, based on the image of the weld pool, a state inside a weld portion formed by the weld pool solidifying. The controller predicts the state inside the weld portion based on at least one of a variance of a change amount of a luminance of a surface of the weld pool, a number of spatter at the surface of the weld pool, or a number of bubbles at the surface of the weld pool.

Embodiments will now be illustrated with reference to the drawings. Similar components in the drawings are marked with the same reference numerals; and a detailed description is omitted as appropriate.

For example, the laser welding device and the laser welding method according to the embodiment can be used to weld a butt-joint portion of two plates, to weld end portions of wire-shaped members arranged proximate to each other, etc. However, the applications of the laser welding device and the laser welding method according to the embodiment are not limited to those illustrated.

An example will now be described in which end portions of rectangular wires including copper are welded to each other.

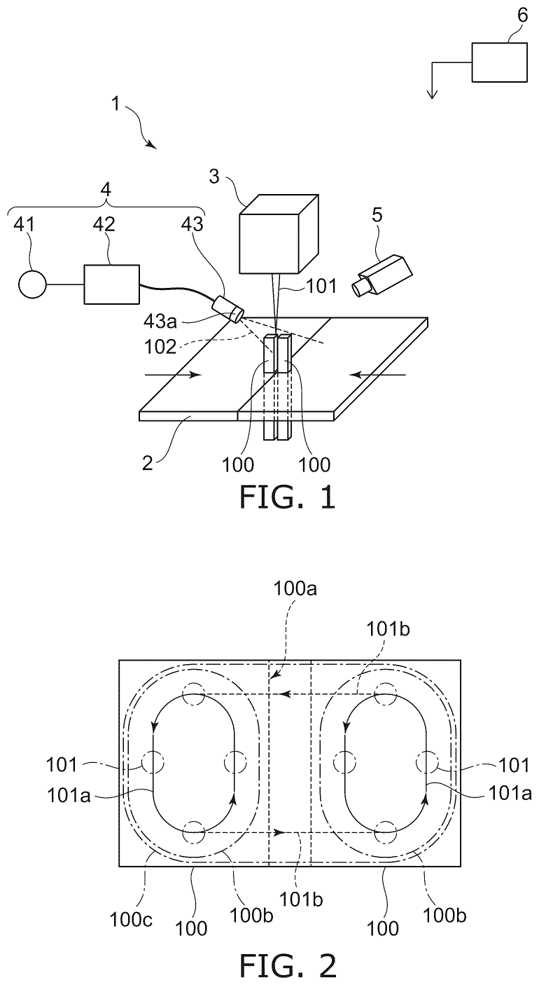

FIG. 1 is a schematic view illustrating a laser welding device 1 according to the embodiment.

As shown in FIG. 1, the laser welding device 1 includes, for example, a holding part 2, a laser irradiation part 3, a shielding gas supply part 4, a detecting part 5, and a controller 6.

For example, the holding part 2 holds two wire-shaped members 100 in an arranged state. The cross-sectional shape of the wire-shaped member 100 in directions orthogonal to the axis direction is, for example, quadrilateral. The wire-shaped member 100 is, for example, a rectangular wire. The cross-sectional dimensions of the wire-shaped member 100 in the directions orthogonal to the axis direction are, for example, about 1 mm to 4 mm. The wire-shaped member 100 includes a material having a high conductivity. The wire-shaped member 100 includes, for example, so-called pure copper or a material having copper as a major component.

The side surfaces (e.g., the surfaces parallel to the axis direction) of the wire-shaped member 100 may be covered with an insulating film. The insulating film includes, for example, enamel, etc. However, at the vicinity of the end portions of the wire-shaped members 100 to be welded, the insulating film is not provided, and the end portions and side surfaces of the wire-shaped members 100 are exposed.

The laser irradiation part 3 irradiates a laser beam on the welding position of the wire-shaped members 100. The laser irradiation part 3 can be, for example, a fiber laser welding device, a disk laser welding device, etc. It is favorable for the laser irradiation part 3 to be a CW laser (continuous wave laser) welding device configured to continuously emit a laser beam 101. The laser irradiation part 3 can move the irradiation position of the laser beam 101. For example, the laser irradiation part 3 can include a scanning device such as a galvano mirror, etc.

The laser irradiation part 3 can be configured to emit the laser beam 101 of a wavelength in the infrared region or a wavelength in the blue to green region. In such a case, when the laser irradiation part 3 is configured to emit the laser beam 101 of a wavelength in the infrared region, it is easy to irradiate the laser beam 101 with a relatively high output. For example, the output of the laser irradiation part 3 can be about 4 kW.

The shielding gas supply part 4 supplies a shielding gas 102 to the welding position of the wire-shaped members 100. For example, the shielding gas supply part 4 supplies the shielding gas 102 to the end portions of the two wire-shaped members 100 arranged proximate to each other. The shielding gas 102 can be, for example, an inert gas such as nitrogen gas, etc.

The shielding gas supply part 4 includes, for example, a gas source 41, a gas controller 42, and a nozzle 43.

The gas source 41 is connected with the gas controller 42 via a pipe, etc. The gas source 41 can be, for example, a high-pressure cylinder in which the shielding gas 102 is stored, factory piping, etc. The gas source 41 may be configured to selectively supply multiple types of shielding gases 102. For example, the gas source 41 can be configured to selectively supply nitrogen gas and helium gas.

The gas controller 42 can adjust at least one of the pressure, flow rate, or type of the shielding gas 102 supplied from the nozzle 43 to the welding position of the wire-shaped members 100. The gas controller 42 also can control the start of the supply of the shielding gas 102 and the stop of the supply of the shielding gas 102.

The nozzle 43 forces the shielding gas 102 toward the welding position of the wire-shaped members 100. The nozzle 43 also can include an adjusting device 43a adjusting at least one of the supply position or the supply range of the shielding gas 102. For example, the adjusting device 43a can adjust the supply position of the shielding gas 102 with respect to the welding position of the wire-shaped members 100 by changing the opening position of the nozzle 43 and/or the angle of the nozzle 43. For example, the adjusting device 43a can adjust the supply range of the shielding gas 102 with respect to the welding position of the wire-shaped members 100 by changing the 25 opening dimension of the nozzle 43.

In other words, the shielding gas supply part 4 is configured to adjust at least one of the supply position of the shielding gas 102, the supply range of the shielding gas 102, the pressure of the shielding gas 102, the flow rate of the shielding gas 102, or the type of the shielding gas 102.

The imaging part 5 images an image of the position at which the laser beam 101 is irradiated. For example, the imaging part 5 images an image of a weld pool formed by irradiating the laser beam 101 on the end portions of the two wire-shaped members 100. The imaging part 5 can include, for example, a CCD sensor, a CMOS sensor, etc. The imaging part 5 also can include, for example, a lens enlarging the image of the weld pool, a filter transmitting light of a prescribed wavelength region included in the light emitted from the weld pool, etc. The imaging part 5 may image a video image of the weld pool, or may continuously image still images of the weld pool.

The controller 6 controls operations of the components included in the laser welding device 1. The controller 6 includes, for example, a calculation part such as a CPU or the like, a storage part such as semiconductor memory, etc. The controller 6 is, for example, a computer. For example, control programs that control the operations of the components included in the laser welding device 1 are stored in the storage part. The calculation part controls the operations of the components included in the laser welding device 1 based on the control programs stored in the storage part.

For example, the controller 6 controls the laser irradiation part 3 to irradiate the laser beam 101 on the end portions of the two wire-shaped members 100. At this time, the controller 6 controls a scanning device such as a galvano mirror, etc., to move the irradiation position of the laser beam 101.

For example, the controller 6 controls the gas controller 42 to control the start of the supply of the shielding gas 102 and the stop of the supply of the shielding gas 102. The controller 6 also controls the gas controller 42 to control at least one of the pressure or the flow rate of the shielding gas 102 supplied from the nozzle 43 to the welding position of the wire-shaped members 100. The controller 6 controls the adjusting device 43a to control at least one of the supply position of the shielding gas 102 with respect to the welding position of the wire-shaped members 100 or the supply range of the shielding gas 102 with respect to the welding position of the wire-shaped members 100.

For example, the state inside the weld portion formed by the weld pool solidifying is predicted by the controller 6 based on the image of the weld pool imaged by the imaging part 5. For example, the controller 6 predicts the state inside the weld portion based on at least one of the variance of the change amount of the luminance of the surface of the weld pool, the number of spatter at the surface of the weld pool, or the number of bubbles at the surface of the weld pool. For example, the state inside the weld portion is the number of blow holes inside the weld portion, etc. The controller 6 also can perform a defect determination of the weld portion based on the predicted state inside the weld portion.

For example, when it is determined that there is a defect in the weld portion, the controller 6 controls the shielding gas supply part 4 to adjust at least one of the supply position of the shielding gas 102, the supply range of the shielding gas 102, the pressure of the shielding gas 102, the flow rate of the shielding gas 102, or the type of the shielding gas 102. In other words, when it is determined that there is a defect in the weld portion, the controller 6 optimizes the shielding by the shielding gas 102 at the welding position of the wire-shaped members 100.

When it is determined that there is a defect in the weld portion, the controller 6 also can rework the weld portion determined to have the defect. For example, when it is determined that there is a defect in the weld portion, the controller 6 controls the laser irradiation part 3 to rework by irradiating the laser beam 101 on the weld portion determined to have the defect to melt the weld portion. When melting the weld portion, the controller 6 causes the laser beam 101 to reach the wire-shaped members 100 under the weld portion.

Details related to predicting the state inside the weld portion, the defect determination of the weld portion, and reworking the weld portion determined to have the defect are described below.

A laser welding method according to the embodiment will now be described.

For example, the laser welding method according to the embodiment can be performed by using the laser welding device 1 described above.

FIG. 2 is a schematic view illustrating laser welding of the end portions of the two wire-shaped members 100.

Although FIG. 2 illustrates an example in which a gap 100a is formed between the end portions of the two wire-shaped members 100, the application can be similar when, for example, the end portions of the two wire-shaped members 100 are caused to contact each other (when there is no gap 100a) by the holding part 2 described above holding the two wire-shaped members 100.

First, the shielding gas 102 is supplied to the end portions of the two wire-shaped members 100.

Then, as shown in FIG. 2, the laser beam 101 is alternately irradiated on the end portion of one wire-shaped member 100 and the end portion of the other wire-shaped member 100 adjacent to the one wire-shaped member 100. By alternately irradiating the laser beam 101, the end portions of the two wire-shaped members 100 each are melted, and two weld pools 100b are formed. The weld pools 100b gradually enlarge as the melting of the end portions of the two wire-shaped members 100 progresses. When the two weld pools 100b become large, the two weld pools 100b unite to form a weld pool 100c straddling the two end portions. At this time, the opening of the gap 100a is covered with the weld pool 100c.

In such a case, for example, the laser beam 101 can be irradiated by performing the following procedure.

First, as shown in FIG. 2, the laser beam 101 is irradiated along a movement path 101a of the irradiation position of the laser beam 101 having a loop shape at the end portion of the one wire-shaped member 100.

Then, the irradiation of the laser beam 101 is stopped, and the irradiation position of the laser beam 101 is moved along a movement path 101b of the irradiation position of the laser beam 101 having a linear shape from the end portion of the one wire-shaped member 100 to the end portion of the other wire-shaped member 100.

Then, the irradiation of the laser beam 101 is restarted at the end portion of the other wire-shaped member 100; and the laser beam 101 is irradiated along the movement path 101a of the irradiation position of the laser beam 101 having the loop shape.

Then, the irradiation of the laser beam 101 is stopped; and the irradiation position of the laser beam 101 is moved along the movement path 101b of the irradiation position of the laser beam 101 having a linear shape from the end portion of the other wire-shaped member 100 to the end portion of the one wire-shaped member 100.

For example, the movement of the irradiation position of the laser beam 101 can be performed by a scanning device such as a galvano mirror or the like included in the laser welding device 1.

By multiply repeating a procedure such as that described above, the weld pools 100b are formed respectively at the end portions of the two wire-shaped members 100. As the melting of the end portions of the two wire-shaped members 100 progresses, the two weld pools 100b gradually become large, and so the two weld pools 100b unite to form the weld pool 100c straddling the two end portions. At this time, the opening of the gap 100a is covered with the weld pool 100c.

Then, after the weld pool 100c is formed, the irradiation of the laser beam 101 is stopped. For example, the formation of the weld pool 100c can be determined from the image that is imaged by the imaging part 5. When the irradiation of the laser beam 101 is stopped, the weld pool 100c cools and solidifies, and a weld portion that joins the end portions of the two wire-shaped members 100 is formed.

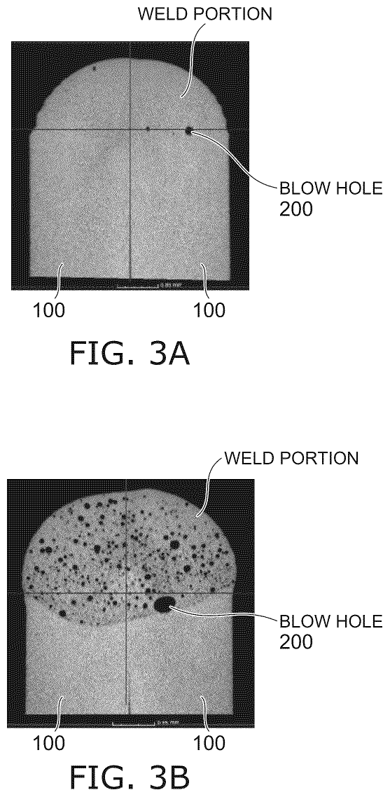

Here, there are cases where small spaces called blow holes occur inside the weld portion. FIGS. 3A and 3B are photographs illustrating blow holes 200. FIGS. 3A and 3B are photographs of weld portions imaged using X-rays.

It can be seen from FIG. 3A that there are also cases where the number of the blow holes 200 occurring is low; and it can be seen from FIG. 3B that there are also cases where the number of the blow holes 200 occurring is high. When the blow holes 200 are inside the weld portion, the substantial cross-sectional area of the weld portion is reduced, and so the tensile strength of the weld portion may be reduced, and/or the tensile strength of the weld portion may fluctuate. For example, in the case of FIG. 3A, the number of the blow holes 200 is low, and so the tensile strength is about 301 N. In the case of FIG. 3B, the number of the blow holes 200 is high, and so the tensile strength is about 178 N.

Here, it is considered that the blow holes 200 are caused by a gas (e.g., air, etc.) at the vicinity of the wire-shaped members 100 mixing in the shielding gas 102 supplied to the welding position of the wire-shaped members 100 when the weld pools 100b and 100c are formed by irradiating the laser beam 101 on the end portions of the wire-shaped members 100.

In other words, it is considered that the blow holes 200 are caused by a gas at the vicinity of the wire-shaped members 100 being trapped inside the weld pools 100b and 100c.

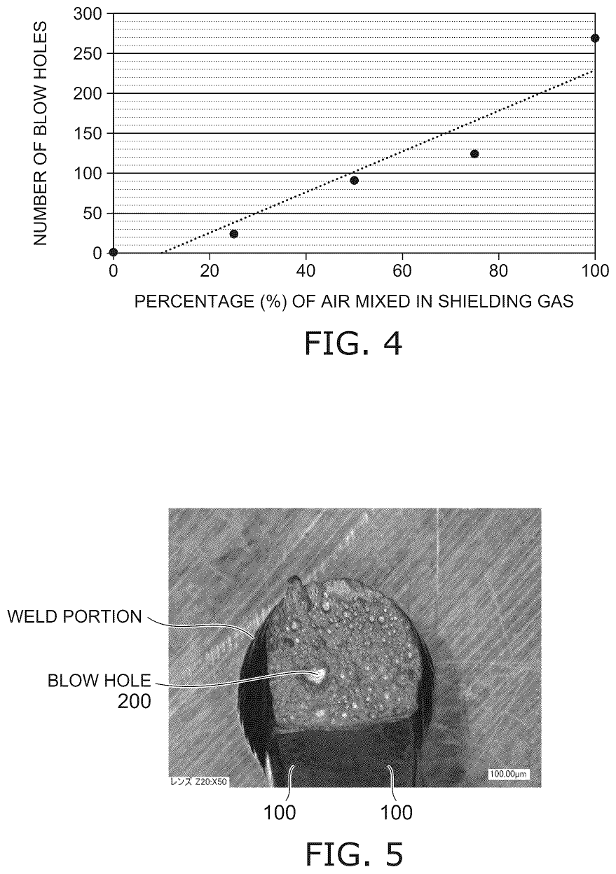

FIG. 4 is a graph illustrating a relationship between the percentage of air mixing in the shielding gas 102 and the occurrence count of the blow holes 200.

As can be seen in FIG. 4, the number of the blow holes 200 increases as the percentage of air mixing in the shielding gas 102 increases. Also, by covering the vicinity of the end portions of the wire-shaped members 100 with the shielding gas 102, the blow holes 200 can be prevented from occurring.

As described above, by the adjusting device 43a adjusting at least one of the supply position or the supply range of the shielding gas 102 with respect to the weld pools 100b and 100c, the vicinity of the end portions of the wire-shaped members 100 can be covered with the shielding gas 102.

Also, by the gas controller 42 adjusting at least one of the pressure, the flow rate, or the type of the shielding gas 102, the vicinity of the end portions of the wire-shaped members 100 can be covered with the shielding gas 102.

As can be seen in FIG. 4, it is considered that by covering the vicinity of the end portions of the wire-shaped members 100 with the shielding gas 102, the occurrence of the blow holes 200 can be suppressed.

However, it is difficult to determine whether or not the vicinity of the end portions of the wire-shaped members 100 is covered with the shielding gas 102. It is therefore necessary to predict the occurrence of the blow holes 200.

FIG. 5 is a photograph illustrating a method for confirming the occurrence of the blow holes 200.

FIG. 5 is a photograph of a weld portion that has been cut.

As can be seen in FIG. 5, the blow holes 200 can be visually checked by cutting the weld portion. However, the weld portion can no longer be used as a product when cut. Therefore, the occurrence of the blow holes 200 cannot be determined for all of the weld portions.

In such a case, as shown in FIGS. 3A and 3B, the occurrence of the blow holes 200 can be determined by imaging the weld portion with X-rays. However, the time and effort necessary for the imaging makes it difficult to determine the occurrence of the blow holes 200 for all weld portions.

Therefore, in the laser welding method according to the embodiment, the occurrence of the blow holes 200 is predicted as follows.

As described above, the blow holes 200 are caused by gas being trapped inside the weld pools 100b and 100c. In such a case, at least a portion of the gas inside the weld pool 100c is discharged outside from the surface of the weld pool 100c. Therefore, it can be predicted based on the state of the surface of the weld pool 100c whether or not there is gas inside the weld pool 100c, and even whether or not the blow holes 200 will occur inside the weld portion.

For example, when the gas inside the weld pool 100c is discharged outside from the surface of the weld pool 100c, the surface of the weld pool 100c deforms locally. Therefore, by determining the change amount of the luminance of the surface of the weld pool 100c, it is possible to predict the discharge of the gas from the weld pool 100c, and even the occurrence of the blow holes 200.

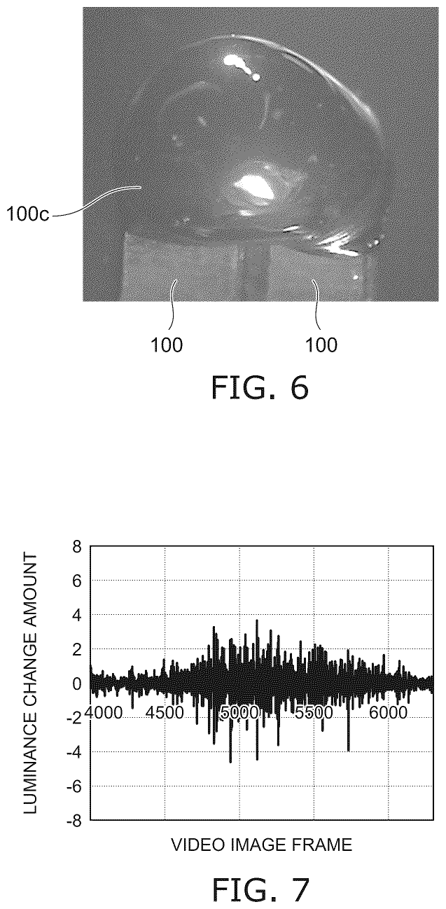

FIG. 6 is a photograph illustrating the luminance of the surface of the weld pool 100c.

For example, the luminance of the surface of the weld pool 100c can be determined from the image data of the weld pool 100c imaged by the imaging part 5 described above.

FIG. 7 is a graph illustrating the change amount of the luminance of the surface of the weld pool 100c.

FIG. 7 is a graph plotting the change amount of the luminance from the luminance of the one-previous image frame. For the case illustrated in FIG. 7, the variance of the change amount of the luminance was 0.488.

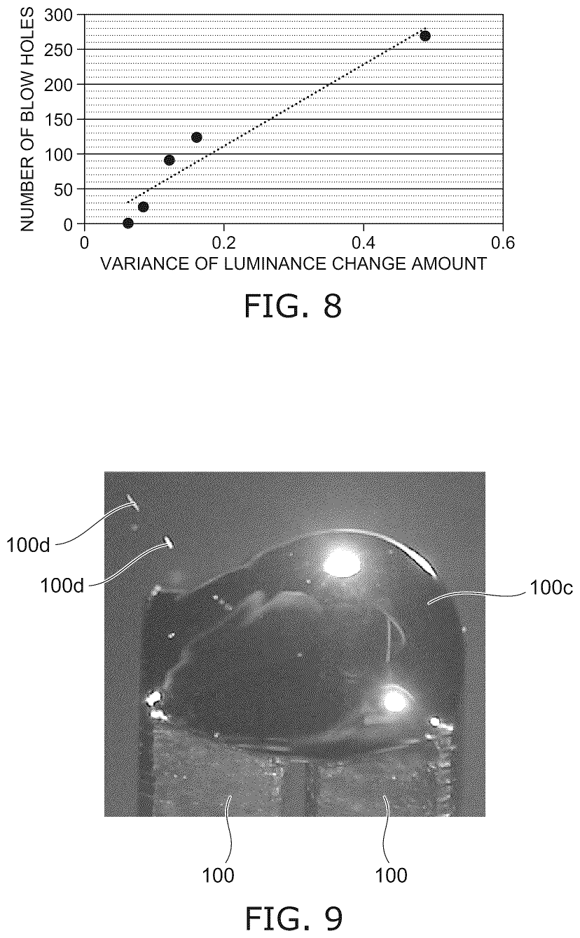

FIG. 8 is a graph illustrating a relationship between the variance of the change amount of the luminance and the number of the blow holes 200.

As can be seen in FIG. 8, the number of the blow holes 200 increases as the variance of the change amount of the luminance of increases. For the case illustrated in FIG. 8, the correlation function between the variance of the change amount of the luminance and the number of the blow holes 200 was 0.98.

For example, for the case illustrated in FIG. 7, the variance of the change amount of the luminance was 0.488, and so it can be predicted that about 300 blow holes 200 will occur.

For example, the controller 6 calculates the variance of the change amount of the luminance from the data of the image of the weld pool 100c imaged by the imaging part 5. Then, the controller 6 predicts the number of the blow holes 200 that will occur based on a predetermined correlation function between the variance of the change amount of the luminance and the number of the blow holes 200. As described above, there is a negative correlation between the number of the blow holes 200 and the tensile strength of the weld portion. Therefore, the controller 6 determines the tensile strength of the weld portion from the predicted number of the blow holes 200, and can determine that there is a defect in the weld portion when the determined tensile strength is not more than a prescribed threshold.

When the gas is discharged from the weld pool 100c, there are cases where spatter (scattered molten metal) occurs.

FIG. 9 is a photograph illustrating spatter 100d.

For example, the spatter 100d can be detected in the image data of the weld pool 100c imaged by the imaging part 5 described above.

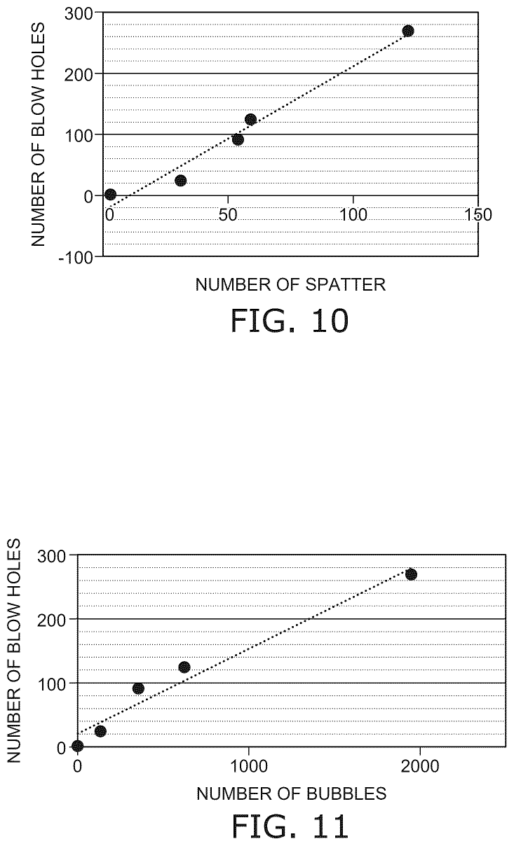

FIG. 10 is a graph illustrating a relationship between the number of the spatter 100d and the number of the blow holes 200.

As can be seen in FIG. 10, the number of the blow holes 200 increases as the number of the spatter 100d increases. For the case illustrated in FIG. 10, the correlation function between the number of the spatter 100d and the number of the blow holes 200 was 0.99.

For example, the controller 6 determines the number of the spatter 100d from the data of the image of the weld pool 100c imaged by the imaging part 5. Then, the controller 6 predicts the number of the blow holes 200 that will occur based on a predetermined correlation function between the number of the spatter 100d and the number of the blow holes 200. As described above, there is a negative correlation between the number of the blow holes 200 and the tensile strength of the weld portion. Therefore, the controller 6 determines the tensile strength of the weld portion based on the predicted number of the blow holes 200, and can determine that there is a defect in the weld portion when the determined tensile strength is not more than the prescribed threshold.

There are cases where bubbles occur in the surface of the weld pool 100c when a gas is discharged from the weld pool 100c.

FIG. 11 is a graph illustrating a relationship between the number of bubbles and the number of the blow holes 200.

As can be seen in FIG. 11, the number of the blow holes 200 increases as the number of bubbles increases. For the case illustrated in FIG. 11, the correlation function between the number of bubbles and the number of the blow holes 200 was 0.98.

For example, the controller 6 determines the number of bubbles from the data of the image of the weld pool 100c imaged by the imaging part 5. Then, the controller 6 predicts the number of the blow holes 200 that will occur based on a predetermined correlation function between the number of bubbles and the number of the blow holes 200. As described above, there is a negative correlation between the number of the blow holes 200 and the tensile strength of the weld portion. Therefore, the controller 6 determines the tensile strength of the weld portion from the predicted number of the blow holes 200, and can determine that there is a defect in the weld portion when the determined tensile strength is not more than the prescribed threshold.

Also, it can be determined whether or not there is a defect in the weld portion by appropriately combining the prediction of the number of the blow holes 200 using the variance of the change amount of the luminance, the prediction of the number of the blow holes 200 using the number of the spatter 100d, and the prediction of the number of the blow holes 200 using the number of bubbles.

The detection of the luminance of the surface of the weld pool 100c, the spatter 100d, and the bubbles can be performed after the weld pool 100c is formed and the irradiation of the laser beam 101 has been stopped and before the weld portion is formed by the solidification of the weld pool 100c.

Here, the spatter 100d and the bubbles are small and appear only briefly. It is therefore difficult to detect the spatter 100d and the bubbles. In contrast, the luminance of the surface of the weld pool 100c can be relatively easily detected. Therefore, the number of the blow holes 200 can be easily and accurately predicted by using the variance of the change amount of the luminance to predict the number of the blow holes 200. As a result, the reliability of the determination of whether or not there is a defect in the weld portion can be increased.

When it is determined that there is a defect in the weld portion, the adjustment described above is performed to optimize the shielding by the shielding gas 102 at the welding position of the wire-shaped members 100. If, however, only the optimization of the shielding is performed, the product determined to have a defect in the weld portion must be scrapped.

In such a case, the yield of the product can be increased by reworking the product determined to have a defect in the weld portion as well as optimizing the shielding.

For example, reworking can be performed as follows.

When it is determined that there is a defect in the weld portion, the weld portion determined to have the defect is melted by irradiating the laser beam 101 on the weld portion after optimizing the shielding by performing the adjustment described above. After the weld portion is melted, the irradiation of the laser beam 101 is stopped, and the weld portion is re-formed by solidification of the molten weld portion.

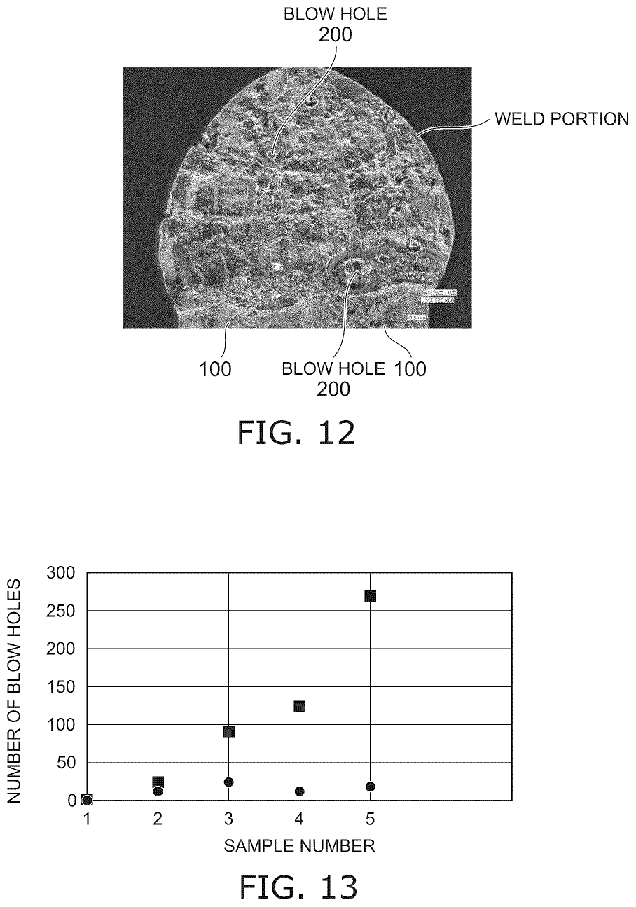

FIG. 12 is a photograph illustrating a cross section of a reworked weld portion.

As can be seen in FIG. 12, the number of the blow holes 200 inside the weld portion can be reduced by reworking.

In the case of the reworked weld portion illustrated in FIG. 12, the number of the blow holes 200 remaining in the lower portion of the weld portion is greater than the number of the blow holes 200 remaining in the upper portion of the weld portion. The number of the blow holes 200 remaining in the lower portion of the weld portion can be reduced by causing the weld portion that is melted when reworking to reach the wire-shaped members 100. For example, when melting the weld portion, the controller 6 causes the laser beam 101 to reach the wire-shaped members 100 under the weld portion. For example, the position of the molten weld portion can be controlled by using the output of the laser beam 101 and the irradiation time of the laser beam 101.

FIG. 13 is a graph illustrating effects of reworking.

In FIG. 13, the black squares illustrate when reworking was not performed. In FIG. 13, the black circles illustrate when reworking was performed.

Sample number 1 was when the percentage of the air mixed in the shielding gas 102 in FIG. 4 was 0%.

Sample number 2 was when the percentage of the air mixed in the shielding gas 102 in FIG. 4 was 25%.

Sample number 3 was when the percentage of the air mixed in the shielding gas 102 in FIG. 4 was 50%.

Sample number 4 was when the percentage of the air mixed in the shielding gas 102 in FIG. 4 was 75%.

Sample number 5 was when the percentage of the air mixed in the shielding gas 102 in FIG. 4 was 100%. In other words, sample number 5 was when the shielding gas 102 was not supplied.

As can be seen in FIG. 13, the number of the remaining blow holes 200 can be drastically reduced by reworking.

When reworking is performed, for example, the output of the laser beam 101 irradiated from the laser irradiation part 3 can be reduced, and the time that the weld portion is molten can be lengthened. By increasing the time that the weld portion is molten, the opportunity for discharging the gas included in the molten weld portion can be increased. Therefore, the number of the remaining blow holes 200 in the reworked weld portion can be reduced.

When reworking, for example, the gas included in the molten weld portion can be discharged outside by moving the irradiation position of the laser beam 101.

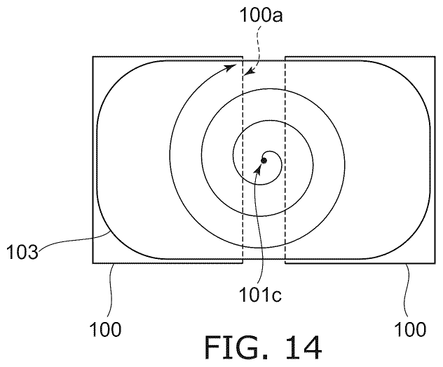

FIG. 14 is a schematic view illustrating a movement path of the irradiation position of the laser beam 101 when reworking.

As shown in FIG. 14, for example, a start point 101c of the irradiation of the laser beam 101 can be set to a position between the end portion of the one wire-shaped member 100 and the end portion of the other wire-shaped member 100 (e.g., the center of the gap 100a). For example, the end point of the irradiation of the laser beam 101 can be set to the position of the end portion of the one wire-shaped member 100 or the position of the end portion of the other wire-shaped member 100.

Then, the irradiation position of the laser beam 101 is moved. In such a case, as shown in FIG. 14, the irradiation position of the laser beam 101 can gradually move away from the start point 101c while turning around the start point 101c. In such a case, the shape of the movement path of the irradiation position of the laser beam 101 can be set to gradually move away from the start point 101c while turning around the start point 101c. For example, as shown in FIG. 14, the shape of the movement path of the irradiation position of the laser beam 101 can be set to be a spiral shape.

The turning direction of the movement path is not particularly limited. For example, the turning direction may be clockwise or counterclockwise. The shape and/or number of turns of the movement path can be modified as appropriate.

By setting the shape of the movement path of the irradiation position of the laser beam 101 to gradually move away from the start point 101c while turning around the start point 101c, a flow can be formed inside a molten weld portion 103 from the center toward the perimeter edge. Therefore, the gas that is included inside the molten weld portion 103 can be discharged outside the molten weld portion 103.

Also, due to the flow inside the molten weld portion 103 (the flow from the center toward the perimeter edge), the gas that is included inside the molten weld portion 103 can be discharged outside the molten weld portion 103 by the impact when the laser beam 101 is incident.

As described above, the laser welding method according to the embodiment can include the following processes:

A process of irradiating the laser beam 101 on the welding position of the wire-shaped members 100 supplied with the shielding gas 102.

A process of imaging the image of the weld pool 100c formed by the irradiation of the laser beam 101.

A process of predicting, based on the image of the weld pool 100c, the state inside the weld portion formed by the weld pool 100c solidifying.

The process of predicting the state inside the weld portion includes predicting the state inside the weld portion based on at least one of the variance of the change amount of the luminance of the surface of the weld pool 100c, the number of spatter at the surface of the weld pool 100c, or the number of bubbles at the surface of the weld pool 100c.

The laser welding method according to the embodiment can further include the following processes:

A process of performing a defect determination of the weld portion based on the predicted state inside the weld portion.

A process of melting the weld portion determined to have a defect is performed by irradiating the laser beam 101 on the weld portion when the defect is determined to be present in the process of performing the defect determination of the weld portion.

The laser welding method according to the embodiment can further include the following processes:

A process of performing a defect determination of the weld portion based on the predicted state inside the weld portion.

A process of optimizing shielding by the shielding gas 102 at the welding position of the wire-shaped members 100 by adjusting at least one of a supply position of the shielding gas 102, a supply range of the shielding gas 102, a pressure of the shielding gas 102, a flow rate of the shielding gas 102, or a type of the shielding gas 102 when it is determined that there is a defect in the process of performing the defect determination of the weld portion.

In the laser welding method according to the embodiment, the process of melting the weld portion includes causing the molten weld portion to reach the wire-shaped members 100.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A laser welding device, comprising:
a laser irradiation part configured to irradiate a laser beam on a welding position of a member;
a shielding gas supply part configured to supply a shielding gas to the welding position of the member;
an imaging part configured to capture an image of a weld pool formed by irradiating the laser beam on the welding position of the member; and
a controller configured to predict, based on the image of the weld pool, a state inside a weld portion formed by the weld pool solidifying,
the controller predicting the state inside the weld portion based on at least one of a variance of a change amount of a luminance of a surface of the weld pool, a number of spatter at the surface of the weld pool, or a number of bubbles at the surface of the weld pool.

2. The device according to claim 1, wherein
the controller performs a defect determination of the weld portion based on the predicted state inside the weld portion, and
when it is determined that there is a defect in the weld portion, the controller controls the laser irradiation part to melt the weld portion determined to have the defect by irradiating the laser beam on the weld portion.

3. The device according to claim 1, wherein
the shielding gas supply part is configured to adjust at least one of a supply position of the shielding gas, a supply range of the shielding gas, a pressure of the shielding gas, a flow rate of the shielding gas, or a type of the shielding gas,
the controller performs a defect determination of the weld portion based on the predicted state inside the weld portion, and
when it is determined that there is a defect in the weld portion, the controller controls the shielding gas supply part to perform the adjustment to optimize shielding at the welding position of the member by the shielding gas.

4. The device according to claim 2, wherein
the controller melts the weld portion so that the melted weld portion reaches the member.

5. The device according to claim 1, wherein
a number of blow holes that will occur is predicted by the controller based on:
the variance of the change amount of the luminance of the surface of the weld pool; and
a correlation function between the variance of the change amount of the luminance and the number of blow holes, the correlation function being predetermined.

6. The device according to claim 5, wherein
the controller determines a tensile strength of the weld portion based on the predicted number of blow holes, and
when the determined tensile strength is not more than a prescribed threshold, the controller determines that there is a defect in the weld portion.

7. The device according to claim 1, wherein
a number of blow holes that will occur is predicted by the controller based on:
the number of spatter at the surface of the weld pool; and
a correlation function between the number of spatter and the number of blow holes, the correlation function being predetermined.

8. The device according to claim 7, wherein
the controller determines a tensile strength of the weld portion based on the predicted number of blow holes, and
when the determined tensile strength is not more than a prescribed threshold, the controller determines that there is a defect in the weld portion.

9. The device according to claim 1, wherein
a number of blow holes that will occur is predicted by the controller based on:
the number of bubbles at the surface of the weld pool; and
a correlation function between the number of bubbles and the number of blow holes, the correlation function being predetermined.

10. The device according to claim 9, wherein
the controller determines a tensile strength of the weld portion based on the predicted number of blow holes, and
when the determined tensile strength is not more than a prescribed threshold, the controller determines that there is a defect in the weld portion.

11. A laser welding method, comprising:
irradiating a laser beam on a welding position of a member, a shielding gas being supplied to the member;
imaging an image of a weld pool formed by the irradiating of the laser beam; and
predicting, based on the image of the weld pool, a state inside a weld portion formed by the weld pool solidifying,
the predicting of the state inside the weld portion including predicting the state inside the weld portion based on at least one of a variance of a change amount of a luminance of a surface of the weld pool, a number of spatter at the surface of the weld pool, or a number of bubbles at the surface of the weld pool.

12. The method according to claim 11, further comprising:
performing a defect determination of the weld portion based on the predicted state inside the weld portion; and
when it is determined that there is a defect in the defect determination of the weld portion, melting the weld portion determined to have the defect by irradiating the laser beam on the weld portion.

13. The method according to claim 11, further comprising:
performing a defect determination of the weld portion based on the predicted state inside the weld portion; and
when it is determined that there is a defect in the defect determination of the weld portion, optimizing shielding at the welding position of the member by the shielding gas by adjusting at least one of a supply position of the shielding gas, a supply range of the shielding gas, a pressure of the shielding gas, a flow rate of the shielding gas, or a type of the shielding gas.

14. The method according to claim 12, wherein
the melting of the weld portion is performed so that the melted weld portion reaches the member.

15. The method according to claim 11, wherein
in the predicting of the state inside the weld portion, a number of blow holes that will occur is predicted based on:
the variance of the change amount of the luminance of the surface of the weld pool; and
a correlation function between the variance of the change amount of the luminance and the number of blow holes, the correlation function being predetermined.

16. The method according to claim 15, further comprising:
performing a defect determination of the weld portion based on the predicted state inside the weld portion,
the defect determination of the weld portion including determining a tensile strength of the weld portion based on the predicted number of blow holes, and determining that there is a defect in the weld portion when the determined tensile strength is not more than a prescribed threshold.

17. The method according to claim 11, wherein
in the predicting of the state inside the weld portion, a number of blow holes that will occur is predicted based on:
the number of spatter at the surface of the weld pool; and
a correlation function between the number of spatter and the number of blow holes, the correlation function being predetermined.

18. The method according to claim 17, further comprising:
performing a defect determination of the weld portion based on the predicted state inside the weld portion,
the defect determination of the weld portion including determining a tensile strength of the weld portion based on the predicted number of blow holes, and determining that there is a defect in the weld portion when the determined tensile strength is not more than a prescribed threshold.

19. The method according to claim 11, wherein
in the predicting of the state inside the weld portion, a number of blow holes that will occur is predicted based on:
the number of bubbles at the surface of the weld pool; and
a correlation function between the number of bubbles and the number of blow holes, the correlation function being predetermined.

20. The method according to claim 19, further comprising:
performing a defect determination of the weld portion based on the predicted state inside the weld portion,
the defect determination of the weld portion including determining a tensile strength of the weld portion based on the predicted number of blow holes, and determining that there is a defect in the weld portion when the determined tensile strength is not more than a prescribed threshold.
